(19) United States
(12) Patent Application Publication
(10) Pub. No.: US 2025/0153494 A1
(43) Pub. Date: May 15, 2025

(54) PRINTING DEVICE AND PRINTING METHOD

(71) Applicant: SEIKO EPSON CORPORATION, Tokyo (JP)

(72) Inventor: Atsushi IMAMURA, SHIOJIRI-SHI (JP)

(21) Appl. No.: 18/941,551

(22) Filed: Nov. 8, 2024

(30) Foreign Application Priority Data
Nov. 10, 2023 (JP) 2023-192297

(51) Int. Cl. B41J 15/16; B41J 11/00; B41J 11/06; B41J 15/04; B41M 7/00

(52) U.S. Cl. CPC B41J 15/16; B41J 11/0024; B41J 11/06; B41J 15/04; B41M 7/009

(57) ABSTRACT

A printing device 1 includes transport sections 11, 12, and 13; a printing section 3; and a drying section 10, wherein the drying section 10 includes a contact heating section 101 that heats a medium P by contacting a back surface P2 and the transport sections 11, 12, and 13 include a first drive roller 11 that is arranged upstream of the printing section 3 in a transport direction A and applies a transporting force to the medium P, a second drive roller 12 that is arranged between the printing section 3 and the drying section 10 in the transport direction A and contacts the back surface P2 to apply a transporting force to the medium P, and a third drive roller 13 that is arranged downstream of the drying section 10 in the transport direction A and applies a transporting force to the medium P.

The present application is based on, and claims priority from JP Application Serial Number 2023-192297, filed Nov. 10, 2023, the disclosure of which is hereby incorporated by reference herein in its entirety.

### BACKGROUND

### 1. Technical Field

The present disclosure relates to a printing device and a printing method.

### 2. Related Art

In the related art, various printing devices that perform printing by ejecting liquid onto a medium have been used. Among these, there is a printing device that includes a heating section for heating a medium and that is capable of drying liquid that was ejected onto the medium. For example, JP-A-2020-199660 discloses a printing device that performs drying by bringing a heating section into contact with a back surface of a print medium in a drying furnace.

However, in a related art printing device, such as a printing device of JP-A-2020-199660, which includes a drying section that promotes drying of liquid that has landed on a medium by bringing a heating section into contact with the medium, the medium may not be properly transported due to the friction force generated between the medium and the heating section. That is, in a related art printing device including a printing section and a drying section, it is sometimes difficult to transport a medium appropriately.

### SUMMARY

A printing device of the present disclosure for overcoming the above-described problem includes a transport section that transports a medium in a transport direction; a printing section that performs printing by ejecting liquid onto a print surface of the medium transported by the transport section; and a drying section that is arranged downstream of the printing section in the transport direction and that dries the medium printed by the printing section, wherein the drying section includes a contact heating section that heats the medium by contacting a back surface that is a surface opposite from the print surface and the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium.

A printing method of the present disclosure for overcoming the above-described problem is a printing method for a printing device, the printing device including a transport section that transports a medium in a transport direction, a printing section that performs printing by ejecting liquid onto a print surface of the medium transported by the transport section, a drying section that is arranged downstream of the printing section in the transport direction and that dries the medium printed by the printing section, and a platen that is arranged at a position facing the printing section with the medium interposed therebetween and that supports the medium, wherein the drying section includes a contact heating section that heats the medium by contacting a back surface that is a surface opposite from the print surface, the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium, and the printing device includes a first tension measuring section that measures tension applied to the medium at a position upstream of the contact heating section in the transport direction, and a motor that drives the second drive roller, the printing method including transporting and printing the medium so that output of the motor is (T−X)×r/i+N₀+N₁, assuming that T is a target value of tension applied to the medium at a position of the platen in the transport direction, X is tension applied to the medium measured by the first tension measuring section, r is a radius of the second drive roller, i is a gear ratio between the second drive roller and the motor, N₀ is idling torque measured in advance, and N₁ is acceleration torque, which is a product of an inertia moment and an angular velocity of the second drive roller.

### BRIEF DESCRIPTION OF THE DRAWINGS

FIG. 1 is a side view of a printing device according to a first embodiment of the present disclosure.

FIG. 2 is a schematic view of the printing device of FIG. 1.

FIG. 3 is a side view of a printing device according to a second embodiment of the present disclosure.

FIG. 4 is a schematic view of the printing device of FIG. 3.

FIG. 5 is a schematic view of a printing device according to a third embodiment of the present disclosure.

FIG. 6 is a side view of a printing device according to a fourth embodiment of the present disclosure.

FIG. 7 is a schematic configuration diagram of a post-platen discharge roller of the printing device of FIG. 6.

### DESCRIPTION OF EMBODIMENTS

First, the present disclosure will be schematically described.

A printing device according to a first aspect of the present disclosure for overcoming the above-described problem includes a transport section that transports a medium in a transport direction; a printing section that performs printing by ejecting liquid onto a print surface of the medium transported by the transport section; and a drying section that is arranged downstream of the printing section in the transport direction and that dries the medium printed by the printing section, wherein the drying section includes a contact heating section that heats the medium by contacting a back surface that is a surface opposite from the print surface and the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium.

According to the present aspect, the transport section includes a first drive roller that is arranged upstream of the printing section in the transport direction and that applies a transporting force to the medium, a third drive roller that is arranged downstream of the drying section in the transport direction and that applies a transporting force to the medium, and a second drive roller that is arranged between the printing section and the drying section in the transport direction and that contacts the back surface to apply a transporting force to the medium. By providing a roller that applies a transporting force to a medium between the printing section and the drying section, it is possible to appropriately transport the medium even when the friction force generated between the medium and the heating section increases.

A printing device according to a second aspect of the present disclosure is an aspect according to the first aspect, and the first drive roller and the third drive roller are a nip roller pair that nips the print surface and the back surface to apply a transporting force to the medium and the second drive roller is a roller that applies a transporting force to the medium without contacting the print surface.

According to the present aspect, the first drive roller and the third drive roller are a nip roller pair that nips the print surface and the back surface to apply a transporting force to the medium and the second drive roller is a roller that applies a transporting force to the medium without contacting the print surface. Since a nip roller can easily apply a strong transporting force to a medium, the first drive roller and the third drive roller can apply a strong transporting force to the medium. On the other hand, even in a case where liquid applied to a medium is not dried between the printing section and the drying section, since the second drive roller is a roller which applies a transporting force to the medium without contacting the print surface, contact between the second drive roller and liquid can be prevented.

A printing device according to a third aspect of the present disclosure is an aspect according to the first or second aspect, and the printing device further includes a platen that is arranged at a position facing the printing section with the medium interposed therebetween and that supports the medium; a first tension measuring section that measures tension applied to the medium at a position between the printing section and the contact heating section in the transport direction; and a control section that controls output of a motor that drives the second drive roller, wherein the control section controls output of the motor to be (T−X)×r/i+N₀+N₁, assuming that T is a target value of tension applied to the medium at a position of the platen in the transport direction, X is tension applied to the medium measured by the first tension measuring section, r is a radius of the second drive roller, i is a gear ratio between the second drive roller and the motor, N₀ is idling torque measured in advance, and N₁ is acceleration torque, which is a product of an inertia moment and an angular velocity of the second drive roller.

According to the present aspect, the control section controls output of the motor to be (T−X)×r/i+N₀+N₁. By performing control in this manner, the second drive roller can be suitably driven, and a medium can be particularly suitably transported.

A printing device according to a fourth aspect of the present disclosure is an aspect according to the third aspect, and the printing device further includes a first contact heating section as the contact heating section; a second contact heating section that is arranged upstream of the first tension measuring section in the transport direction; and a second tension measuring section that is arranged downstream of the first contact heating section in the transport direction, wherein the control section controls output of the motor to be (T−((1+n)X−nY))×r/i+N₀+N₁, assuming that Y is tension applied to the medium measured by the second tension measuring section and transportation load by the second contact heating section is n times a transportation load by the first contact heating section.

According to the present aspect, in a configuration where the second contact heating section is arranged upstream of the first tension measuring section in the transport direction, the control section controls output of the motor to be (T−((1+n)X−nY))×r/i+N₀+N₁. By performing control in this manner, the second drive roller can be suitably driven, and a medium can be particularly suitably transported.

A printing device according to a fifth aspect of the present disclosure is an aspect according to the fourth aspect, and transportation loads by the first contact heating section and the second contact heating section are the same and the control section controls output of the motor to be (T−(2X−Y))×r/i+N₀+N₁.

According to the present aspect, in a configuration in which transportation loads by the first contact heating section and the second contact heating section are the same, the control section controls output of the motor to be (T−(2X−Y))×r/i+N₀+N₁. By performing control in this manner, the second drive roller can be suitably driven, and a medium can be particularly suitably transported.

A printing device according to a sixth aspect of the present disclosure is an aspect according to the first or second aspect, and the printing device further includes a second drive roller position tension measuring section that measures tension applied to the medium at a position of the second drive roller and a control section that controls output of a motor that drives the second drive roller, wherein the second drive roller position tension measuring section is arranged on a support section of the second drive roller and the control section performs feed-forward control and feedback control on output of the motor based on a measured value of the second drive roller position tension measuring section.

According to the present aspect, the second drive roller position tension measuring section is arranged on a support section of the second drive roller and the control section performs feed-forward control and feedback control on output of the motor based on a measured value of the second drive roller position tension measuring section. By performing control in this manner, the second drive roller can be suitably driven, and a medium can be particularly suitably transported.

A printing device according to a seventh aspect of the present disclosure is an aspect according to the sixth aspect, and the printing device further includes a post-drying tension measuring section that measures tension applied to the medium at a position downstream of the drying section in the transport direction, wherein in the feedback control, the control section performs control such that output of the post-drying tension measuring section becomes a predetermined value.

According to the present aspect, the printing device includes a post-drying tension measuring section that measures a tension applied to the medium at a position downstream of the drying section in the transport direction and, in the feedback control, the control section performs control such that output of the post-drying tension measuring section becomes a predetermined value. By performing control in this manner, the second drive roller can be suitably driven, and a medium can be particularly suitably transported.

A printing device according to an eighth aspect of the present disclosure is an aspect according to the first or second aspect, and the transport section transports the medium by intermittent transport in which a predetermined amount of movement and stop are repeated and the printing section is configured to perform printing by ejecting the liquid onto the print surface while reciprocating along the transport direction during stop in the intermittent transport.

According to the present aspect, the transport section transports the medium by intermittent transport in which a predetermined amount of movement and stop are repeated and the printing section is configured to perform printing by ejecting the liquid onto the print surface while reciprocating along the transport direction during stop in the intermittent transport. In a configuration in which the transportation method and the printing method are adopted, the friction force is likely to be generated between a medium and the heating section, however, by providing the second drive roller that applies a transporting force to the medium between the printing section and the drying section, it is possible to appropriately transport the medium even when the friction force generated between the medium and the heating section increases.

A printing method according to a ninth aspect of the present disclosure is a printing method for a printing device, the printing device including a transport section that transports a medium in a transport direction, a printing section that performs printing by ejecting liquid onto a print surface of the medium transported by the transport section, a drying section that is arranged downstream of the printing section in the transport direction and that dries the medium printed by the printing section, and a platen that is arranged at a position facing the printing section with the medium interposed therebetween and that supports the medium, wherein the drying section includes a contact heating section that heats the medium by contacting a back surface that is a surface opposite from the print surface, the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium, and the printing device includes a first tension measuring section that measures tension applied to the medium at a position upstream of the contact heating section in the transport direction, and a motor that drives the second drive roller, the printing method including transporting and printing the medium so that output of the motor is (T−X)×r/i+N₀+N₁, assuming that T is a target value of tension applied to the medium at a position of the platen in the transport direction, X is tension applied to the medium measured by the first tension measuring section, r is a radius of the second drive roller, i is a gear ratio between the second drive roller and the motor, N₀ is idling torque measured in advance, and N₁ is acceleration torque, which is a product of an inertia moment and an angular velocity of the second drive roller.

According to the present aspect, printing is performed by transporting the medium such that output of the motor is (T−X)×r/i+N₀+N₁. By printing by such a printing method, the second drive roller can be suitably driven, and a medium can be particularly suitably transported.

### First Embodiment

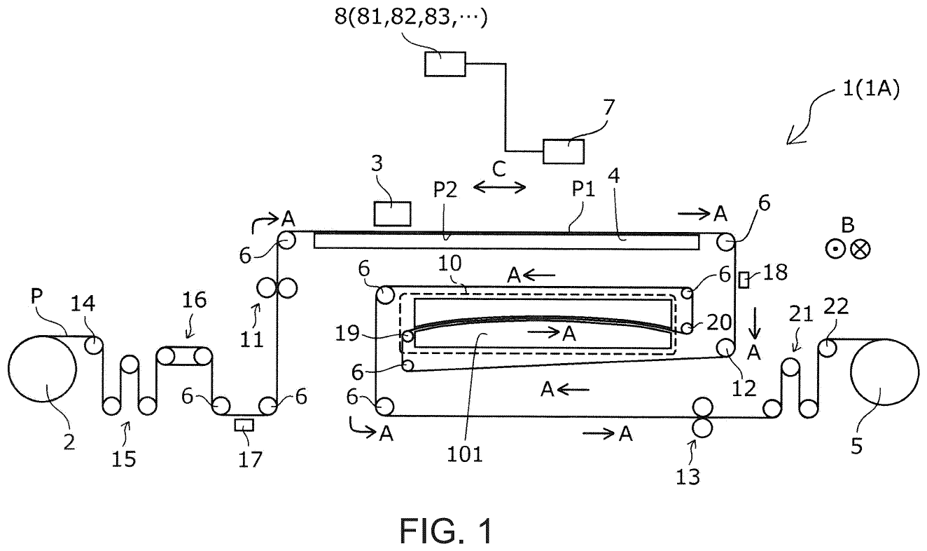

Embodiments of the present disclosure will be specifically described below with reference to the drawings. First, an outline of a printing device 1A of a first embodiment as an example of a printing device 1 of the present disclosure will be described with reference to FIG. 1. As shown in FIG. 1, the printing device 1A of the present embodiment includes a set section 2 that sets a roll-shaped medium P, a winding section 5 that winds up the medium P transported from the set section 2, and a print head 3 as a printing section that forms an image by ejecting liquid ink onto a print surface P1 of the medium P transported in a transport direction A in a transport path from the set section 2 to the winding section 5. The printing device 1A of the present embodiment includes a platen 4 that supports the medium P in an image formation region where an image is formed by the print head 3, and a plurality of driven rollers 6 that are provided in a transport path of the medium P. Furthermore, the printing device 1A of the present embodiment includes a control section 7 including a CPU, a storage section, and the like, and each constituent member of the printing device 1A of the present embodiment is driven by the control of the control section 7.

The print head 3 is provided on a side facing the print surface P1 of the medium P transported in the transport direction A, and forms an image by ejecting ink onto the print surface P1 in a state where a back surface P2 of the medium P, which is on the opposite side from the print surface P1, is supported by the platen 4. In detail, the printing device 1A of the present embodiment performs printing by reciprocating the print head 3 in a scanning direction C along the transport direction A. More specifically, the printing device 1A of the present embodiment intermittently drives (intermittent transport) the medium P in the transport direction A, reciprocates the print head 3 in the scanning direction C, and ejects ink from the print head 3 to perform printing.

The print head 3 of the present embodiment can complete image formation of the entire image formation region supported by the platen 4 on the print surface P1 by one scanning (one path), and can also complete image formation by scanning the entire image formation region a plurality of times (a plurality of paths). As compared with a case where the image formation is completed in one path, in a case where the image formation is completed in a plurality of paths, the transport stop time of the medium P accompanying an intermittent transport is naturally longer.

As described above, the print head 3 of the present embodiment is configured to perform printing by reciprocating in the scanning direction C along the transport direction A. However, a configuration of the print head 3 is not particularly limited. Instead of the print head 3 that performs printing by reciprocating in the scanning direction C along the transport direction A, the print head 3 that performs printing by reciprocating in a width direction B intersecting the transport direction A may be provided, or a so-called line head in which nozzles that eject ink across the entire medium P in the width direction B are arranged along the width direction B and printing is performed in a state where a print head is stopped may be provided.

In a transport path of the medium P from the set section 2 to the print head 3, in addition to the plurality of driven rollers 6, a feed-out tension roller 14, a feed-out dancer roller 15, a web guide 16, a seam sensor 17, and a first drive roller 11 are provided. The feed-out tension roller 14 is a roller that can be adjusted so that tension in the transport direction A of the medium P fed out from the set section 2 becomes a predetermined tension.

The feed-out dancer roller 15 includes a plurality of rollers movable in a vertical direction, and tension of the medium P in the transport direction A in a transport path can be adjusted by changing positions of the rollers in the vertical direction. A nip roller (not shown) is provided upstream of the feed-out dancer roller 15 in the transport direction A, the nip roller detects the position of each roller of the feed-out dancer roller 15, and the control section 7 controls the drive amount or the drive speed of a motor 8 for driving the nip roller so that the nip roller is positioned at a predetermined position.

The web guide 16 includes two rollers which extend in the width direction B and of which an angle with respect to the transport direction A can be adjusted, and it is possible to suppress skew transport of the medium P by adjusting the angle of the rollers by the control of the control section 7 based on a detection result of an end section detection sensor (not shown). The seam sensor 17 is a sensor that detects a seam in cases where a roll-shaped medium P with mediums P connected by tape or the like is used.

The first drive roller 11 is a roller pair including a drive roller that is driven by receiving a driving force from a motor 81 controlled by the control section 7, is arranged upstream of the print head 3 in the transport direction A, and applies a transporting force to the medium P, and a nip roller that is driven to rotate by interposing the medium P between the drive roller and the nip roller. The control section 7 controls the motor 81 so that the first drive roller 11 feeds the medium P by a predetermined transport amount under a predetermined transport condition such as a predetermined speed or acceleration/deceleration. The first drive roller 11 is a nip roller that nips the print surface P1 and the back surface P2 to apply a transporting force to the medium P, however, since the first drive roller 11 is arranged so as to contact the medium P in a region before printing by the print head 3, the first drive roller 11 does not come into contact with ink due to the first drive roller 11 coming into contact with the print surface P1.

As shown in FIG. 1, a drying section 10 for drying ink that was ejected onto the medium P is provided downstream of the print head 3 in the transport direction A in the transport path of the medium P. In addition to the plurality of driven rollers 6, a medium mark sensor 18 and a second drive roller 12 are provided on a transport path of the medium P from the print head 3 to the drying section 10.

The medium mark sensor 18 is a sensor that detects a specific mark formed on the medium P. The control section 7 can control the timing of printing at the time of additional printing by using the medium mark sensor 18.

The second drive roller 12 is a roller that is driven by receiving a driving force of the motor 82, is arranged between the print head 3 and the drying section 10 in the transport direction A, and applies a transporting force to the medium P by contacting the back surface P2. Since the second drive roller 12 is a rubber roller that contacts only the back surface P2 to apply a transporting force to the medium P, the second drive roller 12 does not come into contact with ink due to the second drive roller 12 coming into contact with the print surface P1.

A tension roller 19 and a first contact heating section 101 are provided in a transport path of the medium P in the drying section 10. The first contact heating section 101 is a contact heating section that heats the medium P by contacting the back surface P2.

The tension roller 19 is provided with a load cell 122 that is not shown in FIG. 1, and also serves as a first tension measuring section that measures tension applied to the medium P at a position between the print head 3 and the first contact heating section 101 in the transport direction A. The tension roller 19 may be provided in the drying section 10 as long as it provided at a position between the print head 3 and the first contact heating section 101 in the transport direction A, and may be provided upstream of the drying section 10 as long as it is downstream of the second drive roller 12 in the transport direction A.

In addition to the plurality of driven rollers 6, a tension roller 20, a third drive roller 13, a winding dancer roller 21, and a winding tension roller 22 are provided on a transport path of the medium P from the drying section 10 to the winding section 5. The tension roller 20 is provided with the load cell 122, and serves also as a second tension measuring section that measures tension applied to the medium P at a position downstream of the first contact heating section 101 in the transport direction A.

Here, tension on the platen 4 is detected by the tension roller 20, and the control section 7 can control the torque of a motor 83 of the third drive roller 13 so that tension detected by the tension roller 20 becomes a predetermined tension.

The third drive roller 13 is a roller pair including a drive roller and a nip roller. The drive roller is driven by receiving a driving force of the motor 83, is arranged downstream of the drying section 10 in the transport direction A, and applies a transporting force to the medium P. The nip roller is driven to rotate by the medium P interposed between the drive roller and the nip roller. Although the third drive roller 13 is a roller pair that nips the print surface P1 and the back surface P2 to apply a transporting force to the medium P, the third drive roller 13 does not disturb the ink in an image formation region of the print surface P1 because ink on the print surface P1 is dried by passing through the drying section 10.

In the present embodiment, the motors 8 for driving the first drive roller 11, the second drive roller 12, and the third drive roller 13 are individually provided with the motor 81, the motor 82, and the motor 83, and for the first drive roller 11, the second drive roller 12, and the third drive roller 13, respectively. However, the disclosure is not limited to such a configuration, and the motor 8 that drives the first drive roller 11, the second drive roller 12, and the third drive roller 13 may be, for example, a single common motor 8 that can individually drive the first drive roller 11, the second drive roller 12, and the third drive roller 13 via a gear train.

The winding dancer roller 21 includes a plurality of rollers movable in the vertical direction, and tension of the medium P in the transport direction A in a transport path can be adjusted by changing positions of the rollers in the vertical direction. A nip roller pair (not shown) is provided downstream of the winding dancer roller 21 in the transport direction A, the nip roller pair detects the position of each roller of the winding dancer roller 21, and the control section 7 controls the drive amount or the drive speed of the motor 8 for driving a drive roller of the nip roller pair so that they are at predetermined positions.

The winding tension roller 22 is a roller capable of adjusting tension in the transport direction A of the medium P to be wound around the winding section 5. A tension of the winding section 5 is detected by the winding tension roller 22, and the control section 7 controls the torque of the drive motor 8 of the winding section 5 so as to obtain a predetermined tension. Here, the control section 7 can perform control such that a taper tension corresponds to the roll diameter of the medium P wound around the winding section 5.

As described above, the printing device 1A of the present embodiment includes the print head 3 that performs printing by ejecting ink onto the print surface P1 of the transported medium P, and the drying section 10 that is arranged downstream of the print head 3 in the transport direction A and dries the medium P on which printing has been performed by the print head 3. The drying section 10 includes the first contact heating section 101 as a contact heating section which heats the medium P by contacting the back surface P2. The printing device 1A of the present embodiment includes, as a transport section for transporting the medium P in the transport direction A, the first drive roller 11 that is arranged upstream of the print head 3 in the transport direction A and applies a transporting force to the medium P, the second drive roller 12 that is arranged between the print head 3 and the drying section 10 in the transport direction A and contacts the back surface P2 to apply a transporting force to the medium P, and the third drive roller 13 which is arranged downstream of the drying section 10 in the transport direction A and applies a transporting force to the medium P.

That is, the printing device 1A of the present embodiment includes the second drive roller 12, which is arranged between the print head 3 and the drying section 10 in the transport direction A and contacts the back surface P2 to apply a transporting force to the medium P, in addition to the first drive roller 11, which is arranged upstream of the print head 3 in the transport direction A and applies a transporting force to the medium P, and the third drive roller 13, which is arranged downstream of the drying section 10 in the transport direction A and applies a transporting force to the medium P. As described above, by providing the second drive roller 12, which is a roller for applying a transporting force to the medium P, between the print head 3 and the drying section 10, the medium P can be suitably transported even if the friction force generated between the medium P and the heating section 10 becomes large.

As described above, in the printing device 1A of the present embodiment, the first drive roller 11 and the third drive roller 13 are nip rollers that nip the print surface P1 and the back surface P2 and apply a transporting force to the medium P, and the second drive roller 12 is a roller that applies a transporting force to the medium P without contacting the print surface P1. Since a nip roller can easily apply a strong transporting force to the medium P, the first drive roller 11 and the third drive roller 13 can apply a strong transporting force to the medium P. On the other hand, even in a case where ink applied to the medium P is not dried between the print head 3 and the drying section 10, since the second drive roller 12 is a roller that applies a transporting force to the medium P without contacting the print surface P1, it is possible to suppress contact between the second drive roller 12 and ink.

The second drive roller 12 of the present embodiment is a roller that applies a transporting force to the medium P by contacting only the back surface P2, but is not limited to such a configuration. For example, the second drive roller 12 may be a roller pair including a drive roller and a nip roller that nips the print surface P1 and the back surface P2 at a portion outside an image formation region of the print surface P1 in the width direction B to apply a transporting force to the medium P.

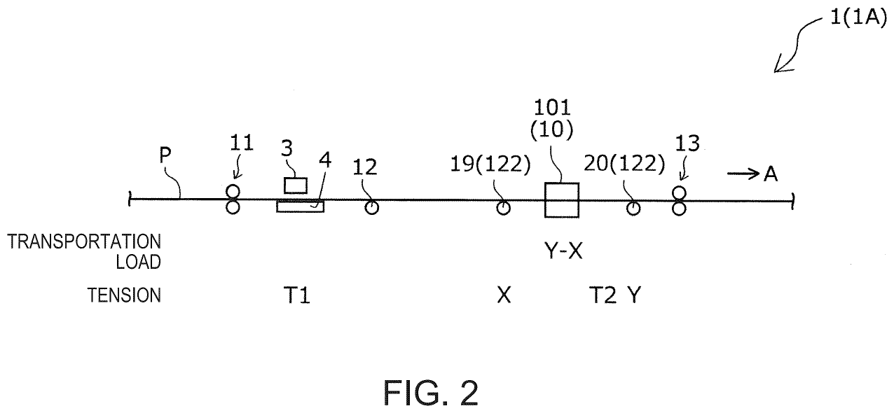

Here, the driving control of the motor 82 by the control section 7 in the printing device 1A of the present embodiment will be described with reference to FIG. 2. As described above, the printing device 1A of the present embodiment includes the tension roller 19 as a first tension measuring section that measures tension applied to the medium P at a position between the print head 3 and the first contact heating section 101 in the transport direction A, and the control section 7 that controls the output of the motor 82 that drives the second drive roller 12. Here, as shown in FIG. 2, when a target value of tension applied to the medium P at a position of the platen 4 is T1 and a target value of tension applied to the medium P at a position directly downstream of the first contact heating section 101 is T2, the control section 7 controls the torque of the motor 83 of the third drive roller 13 so as to compensate for the difference between tension Y, which is detected by the tension roller 20, and the target tension T2. On the other hand, the control section 7 controls the torque of the motor 82 that drives the second drive roller 12 so as to compensate for the difference between tension X detected by the tension roller 19 and the target tension T1.

Specifically, in printing device 1A of the present embodiment, the control section 7 controls the output of the motor 82 that drives the second drive roller 12 to be (T1−X)×r/i+N₀+N₁, assuming that the radius of the second drive roller 12 is r, the gear ratio between the second drive roller 12 and the motor 82 is i, an idling torque of the second drive roller 12 actually measured previously is N₀, and an acceleration torque, which is the product of the inertia moment and the angular velocity of the second drive roller 12, is N₁. By controlling in this manner, the second drive roller 12 can be suitably driven, and the medium P can be particularly suitably transported.

Describing the above from the viewpoint of the printing method, the second drive roller 12 can be suitably driven by using the printing device 1A of the present embodiment and executing the printing method in which the medium P is transported and printed so that the output of the motor 82 becomes (T1−X)×r/i+N₀+N₁. By executing such a printing method, the medium P can be transported particularly suitably.

As shown in FIG. 2, tension applied to the medium P measured by the tension roller 20 is defined as Y. Then, the transportation load in the drying section 10 between the tension roller 19 and the tension roller 20, that is, in the first contact heating section 101 can be regarded as Y−X.

As described above, in the printing device 1A of the present embodiment, the medium P can be transported by a transport section such as the first drive roller 11, the second drive roller 12, and the third drive roller 13 in the intermittent transport in which the medium P is repeatedly moved by a predetermined amount and stopped. The print head 3 is configured to be able to perform printing by ejecting ink onto the print surface P1 while reciprocating in the scanning direction C along the transport direction A at the time of stopping in the intermittent transport. In a configuration adopting such a transportation method and a printing method, friction force generated between the medium P and the first contact heating section 101 is likely to be generated, however, by providing the second drive roller 12 that applies a transporting force to the medium P between the print head 3 and the drying section 10, the medium P can be suitably transported even when friction force generated between the medium P and the first contact heating section 101 increases.

### Second Embodiment

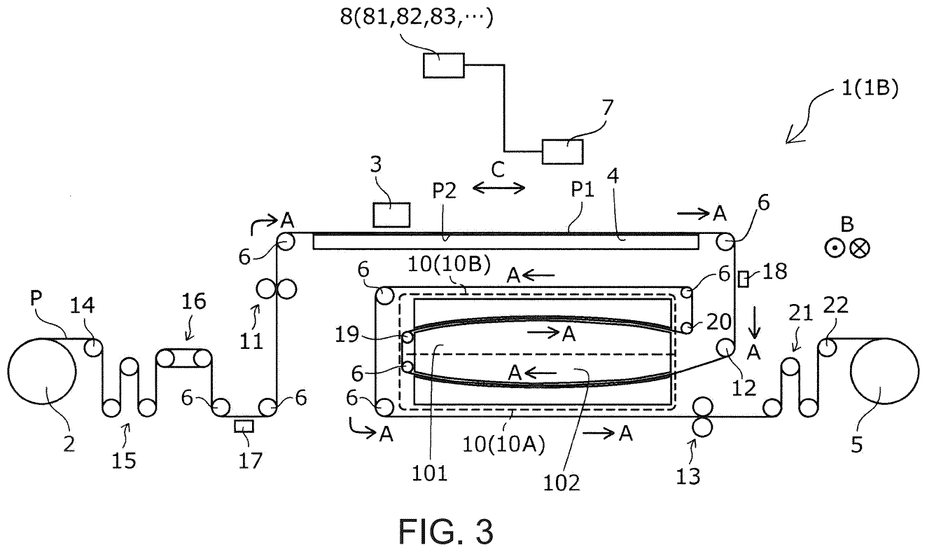

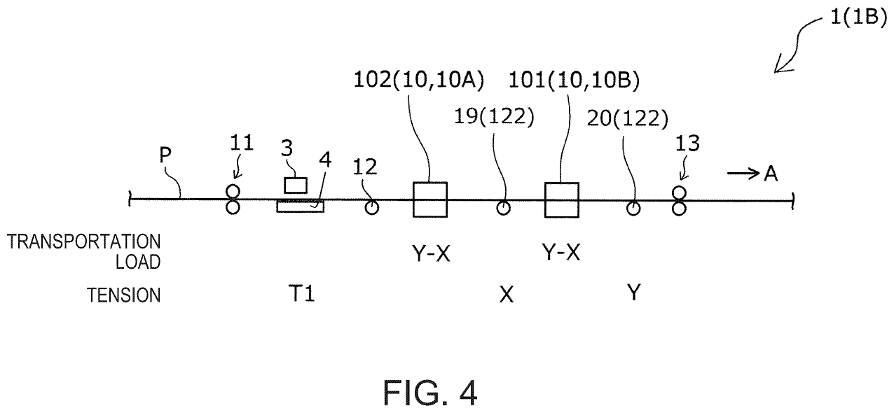

Next, a printing device 1B of a second embodiment will be described with reference to FIGS. 3 and 4. FIG. 3 is a diagram corresponding to FIG. 1 in the printing device 1 of the first embodiment, and FIG. 4 is a diagram corresponding to FIG. 2 in the printing device 1 of the first embodiment. In FIGS. 3 and 4, constituent members that are common to those in the above-described first embodiment are indicated by the same reference symbols, and detailed descriptions are omitted. Here, the printing device 1B of the present embodiment includes the same configuration as the printing device 1A of the first embodiment except for the configuration of the drying section 10. For this reason, the printing device 1B of the present embodiment has the same features as those of the printing device 1A of the first embodiment, except for the parts described below.

As shown in FIG. 3, the printing device 1B of the present embodiment includes, as the drying section 10, a drying section 10B similar to the drying section 10 of the printing device 1A of the first embodiment, and a drying section 10A provided upstream of the tension roller 19 in the transport direction A. The drying section 10A includes the same configuration as the drying section 10B except that the drying section 10B is turned upside down, and includes a second contact heating section 102 including the same configuration as the first contact heating section 101. That is, the printing device 1B of the present embodiment includes the first contact heating section 101 that is the same contact heating section as the first contact heating section 101 of the printing device 1A of the first embodiment, and the second contact heating section 102 that is arranged upstream of the tension roller 19 in the transport direction A. Further, similarly to the printing device 1A of the first embodiment, the printing device 1B of the present embodiment includes tension roller 20 as a second tension measuring section that includes the same configuration as the tension roller 20 of the printing device 1A of the first embodiment and that is arranged downstream of the first contact heating section 101 in the transport direction A.

Here, in the printing device 1B of the present embodiment, the transportation loads by the first contact heating section 101 and the second contact heating section 102 are the same. That is, as shown in FIG. 4, when tension applied to the medium P measured by the tension roller 19 is X and tension applied to the medium P measured by the tension roller 20 is Y, the transportation loads by the first contact heating section 101 and the second contact heating section 102 are both Y−X. Then, tension applied to the medium P at a position of the second drive roller 12 is the difference between the tension X applied to the medium P measured by the tension roller 19 and the transportation load Y−X by the second contact heating section 102, X−(Y−X), that is, 2X−Y. Assuming that a target value of tension applied to medium P at a position on the platen 4 is T1, the control section 7 controls the torque of the motor 82 that drives the second drive roller 12 to compensate for the difference between tension applied to medium P at a position of the second drive roller 12 and the target tension T1. That is, the output of the motor 82 is controlled to be (T1−(2X−Y))×r/i+N₀+N₁. By controlling in this manner, the second drive roller 12 can be suitably driven, and the medium P can be particularly suitably transported. The second embodiment is particularly suitable when a tension roller cannot be arranged between the platen 4 and the drying section 10A in FIG. 3 for physical or functional reasons.

### Third Embodiment

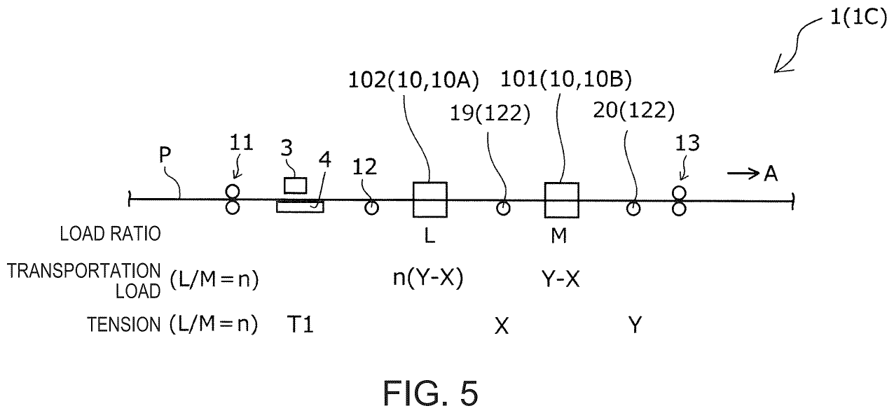

Next, a printing device 1C of a third embodiment will be described with reference to FIG. 5. FIG. 5 is a diagram corresponding to FIG. 2 in the printing device 1 of the first embodiment. In FIG. 5, constituent members that are common to those in the above-described first embodiment and the second embodiment are indicated by the same reference symbols, and detailed descriptions are omitted. Here, a printing device 1C of the present embodiment includes the same configuration as the printing device 1B of the second embodiment except for the configuration of the drying section 10A. That is, the printing device 1C of the present embodiment can be represented in the same manner as in FIG. 3. For this reason, the printing device 1C of the present embodiment has the same features as those of the printing device 1 of the first embodiment and the second embodiment, except for the parts described below.

As described above, in the printing device 1B of the second embodiment, the transportation loads by the first contact heating section 101 and the second contact heating section 102 were the same. On the other hand, in the printing device 1C of the present embodiment, the transportation load by the second contact heating section 102 is n times the transportation load by the first contact heating section 101. In other words, as shown in FIG. 5, the load ratio between the second contact heating section 102 and the first contact heating section 101 is L:M. Note that n corresponds to L/M.

Accordingly, the transportation load by the first contact heating section 101 is Y−X, while the transportation load by the second contact heating section 102 is n(Y−X). Accordingly, tension applied to the medium P at a position of the second drive roller 12 is X−n(Y−X), which is the difference between the tension X applied to the medium P measured by the tension roller 19 and the transportation load n(Y−X) by the second contact heating section 102, that is, (1+n)X−nY. Then, the control section 7 controls the output of the motor 82 to be (T1−((1+n)X−nY))×r/i+N₀+N₁. By controlling in this manner, the second drive roller 12 can be suitably driven, and the medium P can be particularly suitably transported. The printing device 1B of the second embodiment can be regarded as a case where n=1(L:M=1:1) in the printing device 1C of the present embodiment. The third embodiment is particularly suitable when tension roller cannot be arranged between the platen 4 and the drying section 10A in FIG. 5 for physical or functional reasons.

### Fourth Embodiment

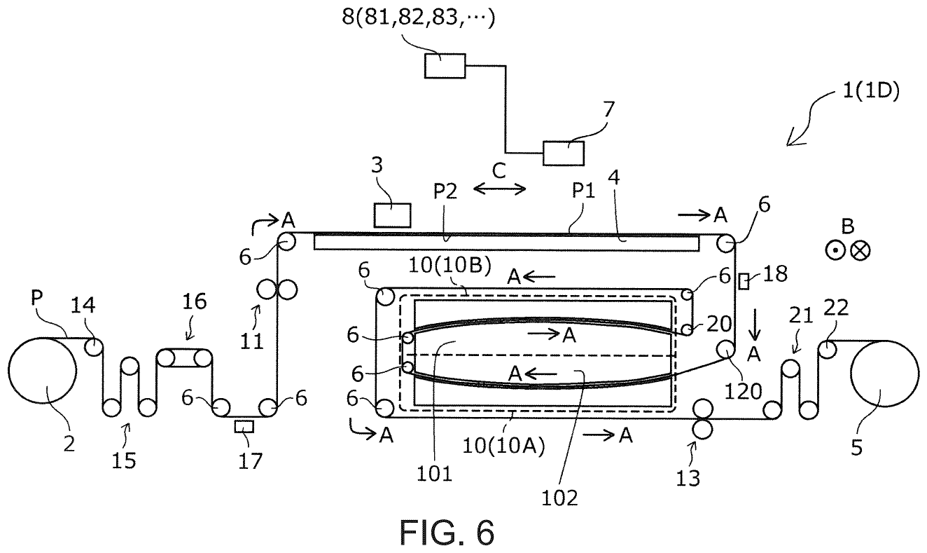

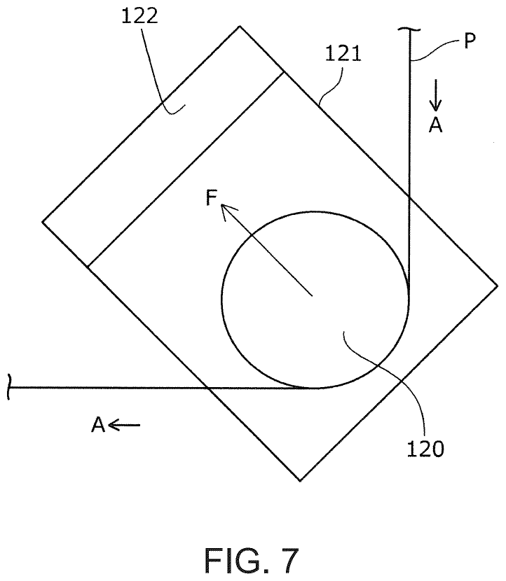

Next, a printing device 1D of a fourth embodiment will be described with reference to FIGS. 6 and 7. FIG. 6 is a diagram corresponding to FIG. 1 in the printing device 1 of the first embodiment. In FIGS. 6 and 7, constituent members that are common to those in the above-described first to third embodiments are indicated by the same reference symbols, and detailed descriptions are omitted. Here, the printing device 1D of the present embodiment includes the same configuration as the printing device 1B of the second embodiment except that the driven roller 6 is provided at the position of the tension roller 19 and a second drive roller 120 to which a load cell 122 is attached is provided instead of the second drive roller 12. For this reason, the printing device 1D of the present embodiment has the same features as those of the printing device 1 of first embodiment to third embodiment, except for the parts described below.

As shown in FIG. 6, the printing device 1D of the present embodiment is different from the printing device 1B of the second embodiment in that the second drive roller 120 to which the load cell 122 as shown in FIG. 7 is attached is provided instead of the second drive roller 12. In other words, the printing device 1D of the present embodiment includes the load cell 122 as a second drive roller position tension measuring section that measures tension applied to the medium P at the position of the second drive roller 120. As shown in FIG. 6, the control section 7 that controls the output of the motor 82 that drives the second drive roller 120 is provided.

Here, as shown in FIG. 7, the load cell 122 as the second drive roller position tension measuring section is arranged on a support section 121 of the second drive roller 120. The load cell 122 measures tension applied to the medium P by measuring the force F applied from the second drive roller 120. The control section 7 can perform feed-forward control and feedback control of the output of the motor 82 based on a measured value of the load cell 122 serving as the second drive roller position tension measuring section. The printing device 1D of the present embodiment can suitably drive the second drive roller 120 and can particularly suitably transport the medium P by feed-forward controlling and feedback controlling the output of the motor 82 in this manner.

As shown in FIG. 6, the printing device 1D of the present embodiment is provided with the tension roller 20 at a position downstream of the drying section 10 in the transport direction A, similarly to the printing devices 1 of the first embodiment to third embodiment, and the tension roller 20 is provided with a load cell 122 (not shown), so that tension applied to the medium P can be measured, and also serves as a post-drying tension measuring section. In the feedback control, the control section 7 can control the output of the tension roller 20 serving as the post-drying tension measuring section to be a predetermined value. The printing device 1D of the present embodiment can suitably drive the third drive roller 13 and particularly suitably transport the medium P by performing control in this manner.

The present disclosure is not limited to the above-described embodiments, and can be realized by various configurations without departing from the scope of the disclosure. For example, the technical features in the embodiments corresponding to the technical features in each aspect described in the outline can be appropriately replaced or combined in order to overcome a part or all of the problems described above or in order to achieve a part or all of the effects described above. If the technical features are not described as essential in this specification, the technical features can be appropriately deleted.

What is claimed is:

1. A printing device comprising:
a transport section that transports a medium in a transport direction;
a printing section that performs printing by ejecting liquid onto a print surface of the medium transported by the transport section; and
a drying section that is arranged downstream of the printing section in the transport direction and that dries the medium printed by the printing section, wherein
the drying section includes a contact heating section that heats the medium by contacting a back surface that is a surface opposite from the print surface and
the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium.

2. The printing device according to claim 1, wherein
the first drive roller and the third drive roller are a nip roller pair that nips the print surface and the back surface to apply a transporting force to the medium and
the second drive roller is a roller that applies a transporting force to the medium without contacting the print surface.

3. The printing device according to claim 1, further comprising:
a platen that is arranged at a position facing the printing section with the medium interposed therebetween and that supports the medium;
a first tension measuring section that measures tension applied to the medium at a position between the printing section and the contact heating section in the transport direction; and a control section that controls output of a motor that drives the second drive roller, wherein
the control section controls output of the motor to be (T−X)×r/i+N₀+N₁, assuming that T is a target value of tension applied to the medium at a position of the platen in the transport direction, X is tension applied to the medium measured by the first tension measuring section, r is a radius of the second drive roller, i is a gear ratio between the second drive roller and the motor, N₀ is idling torque measured in advance, and N₁ is acceleration torque, which is a product of an inertia moment and an angular velocity of the second drive roller.

4. The printing device according to claim 3, further comprising:
a first contact heating section as the contact heating section;
a second contact heating section that is arranged upstream of the first tension measuring section in the transport direction; and
a second tension measuring section that is arranged downstream of the first contact heating section in the transport direction, wherein
the control section controls output of the motor to be (T−((1+n)X−nY))×r/i+N₀+N₁, assuming that Y is tension applied to the medium measured by the second tension measuring section and transportation load by the second contact heating section is n times a transportation load by the first contact heating section.

5. The printing device according to claim 4, wherein
transportation loads by the first contact heating section and the second contact heating section are the same and
the control section controls output of the motor to be (T−(2X−Y))×r/i+N₀+N₁.

6. The printing device according to claim 1, further comprising:
a second drive roller position tension measuring section that measures tension applied to the medium at a position of the second drive roller and
a control section that controls output of a motor that drives the second drive roller, wherein
the second drive roller position tension measuring section is arranged on a support section of the second drive roller and the control section performs feed-forward control and feedback control on output of the motor based on a measured value of the second drive roller position tension measuring section.

7. The printing device according to claim 6, further comprising:
a post-drying tension measuring section that measures tension applied to the medium at a position downstream of the drying section in the transport direction, wherein
in the feedback control, the control section performs control such that output of the post-drying tension measuring section becomes a predetermined value.

8. The printing device according to claim 1, wherein
the transport section transports the medium by intermittent transport in which a predetermined amount of movement and stop are repeated and
the printing section is configured to perform printing by ejecting the liquid onto the print surface while reciprocating along the transport direction during stop in the intermittent transport.

9. A printing method for a printing device, the printing device including a transport section that transports a medium in a transport direction,
a printing section that performs printing by ejecting liquid onto a print surface of the medium transported by the transport section,
a drying section that is arranged downstream of the printing section in the transport direction and that dries the medium printed by the printing section, and
a platen that is arranged at a position facing the printing section with the medium interposed therebetween and that supports the medium, wherein
the drying section includes a contact heating section that heats the medium by contacting a back surface that is a surface opposite from the print surface,
the transport section includes a first drive roller that is arranged upstream of the printing section in the transport direction and that applies a transporting force to the medium, a second drive roller that is arranged between the printing section and the drying section in the transport direction and that contacts the back surface to apply a transporting force to the medium, and a third drive roller that is arranged downstream of the drying section in the transport direction and that applies a transporting force to the medium, and
the printing device includes a first tension measuring section that measures tension applied to the medium at a position upstream of the contact heating section in the transport direction, and a motor that drives the second drive roller,
the printing method comprising:
transporting and printing the medium so that output of the motor is (T−X)×r/i+N₀+N₁, assuming that T is a target value of tension applied to the medium at a position of the platen in the transport direction, X is tension applied to the medium measured by the first tension measuring section, r is a radius of the second drive roller, i is a gear ratio between the second drive roller and the motor, N₀ is idling torque measured in advance, and N₁ is acceleration torque, which is a product of an inertia moment and an angular velocity of the second drive roller.
